(19) United States
(12) Patent Application Publication
(10) Pub. No.: US 2012/0124060 A1
(43) Pub. Date: May 17, 2012

(54) METHOD AND SYSTEM OF IDENTIFYING ADJACENCY DATA, METHOD AND SYSTEM OF GENERATING A DATASET FOR MAPPING ADJACENCY DATA, AND AN ADJACENCY DATA SET

(75) Inventors: Tal MUSKAL, Ramat-HaSharon (IL); Sagie Davidovich, Zikhron-Yaakov (IL)

(73) Assignee: SemantiNet Ltd., Shefayim (IL)

(21) Appl. No.: 13/292,116

(22) Filed: Nov. 9, 2011

Related U.S. Application Data
(60) Provisional application No. 61/412,434, filed on Nov. 11, 2010.

(51) Int. Cl. G06F 17/30; G06F 7/00

(52) U.S. Cl. 707/748; 707/752; 707/E17.058

(57) ABSTRACT

A method of creating a dataset having an adjacency list of a graph mapping a plurality of predicate edges connecting among a plurality of vertexes each set for another of a plurality of entities. The method is based on a list having a plurality of predicate triplets and a plurality of inverted predicate triplets extracted from the graph, each the triplet and the inverted predicate triplet having a subject entity and an attribute entity from the plurality of entities and a predicate edge, from the plurality of predicate edges.

### RELATED APPLICATION

This application claims the benefit of priority under 35 USC 119(e) of U.S. Provisional Patent Application No. 61/412,434 filed Nov. 11, 2010, the contents of which are incorporated herein by reference in their entirety.

### FIELD AND BACKGROUND OF THE INVENTION

The present invention, in some embodiments thereof, relates to a contextual relation records and, more particularly, but not exclusively, to a method and system of identifying contextual relations, method and system of generating a dataset for mapping contextual relation, and an adjacency data set, such as contextual relation data.

During the last years, a number of systems and methods which are adapted to improve computational complexity of data storage and retrieval in data mapped by graphs, for example contextual relation graphs have been developed. For example, U.S. Patent Application No. 2007/0260598 published on Nov. 8, 2007, provides search engine methods and systems for generating highly personalized and relevant search results based on the context of a user's search constraint and user characteristics. In an embodiment, upon receipt of a user's search constraint, the method determines all semantic variations for each word within the user search constraint. Additionally, topics may be determined within the user constraint. For each unique word and topic within the user search constraint, possible contexts are determined. A matrix of feasible context scenarios is established. Each context scenario is ranked to determine the most likely context scenario for which the user searches constraint relates based on user characteristics. In one embodiment, the weighting used to rank the contexts is based on previous user searches and/or knowledge of their interests. Search results associated with the highest ranking context are provided to the user, along with topics associated with lower ranked contexts. Another example is provided in International Patent Application Publication

No. WO/2009/081393 which describes a method for obtaining contextually related instances. The method is based on a map of a plurality of contextual relations between a plurality of instance types and a plurality of functionalities. Each one of the functionalities is associated with one of the mapped contextual relations and configured for providing one or more instances of a respective type. The method further comprises receiving a contextual linkage between a known instance and a requested instance, identifying a match between the contextual linkage and a segment of the map, and obtaining the requested instance by using the known instance along with a group of which is selected from the functionalities; each member of the group is associated with a contextual relation in the segment.

### SUMMARY OF THE INVENTION

According to some embodiments of the present invention, there is provided a method of creating a dataset having an adjacency list of a graph mapping a plurality of predicate edges connecting among a plurality of vertexes each set for another of a plurality of entities. The method comprises providing a list having a plurality of predicate triplets and a plurality of inverted predicate triplets extracted from the graph, each the triplet and the inverted predicate triplet having a subject entity and an attribute entity from the plurality of entities and a predicate edge, from the plurality of predicate edges, defining a relation between the subject entity and the attribute entity, creating a dataset having an adjacency list of the graph, the adjacency list having a plurality of entry records each defining, for a certain entity of the plurality of entities, a group of the plurality of predicate edges which connects some of the plurality of entities thereto, the plurality of entry records being ordered according to a prevalence of each the entity in the list, replacing each the entity in the adjacency list with a unique pointer to a physical memory address of a respective of the plurality of entry records, and outputting the dataset.

Optionally, the graph is a contextual relation graph.

Optionally, the method further comprises generating a matching table for associating between a plurality of vertex keys and a plurality of unique pointers so as to allow converting a received linguistic unit to a certain unique pointer and using the certain unique pointer for selecting one of the plurality of entry records.

Optionally, the providing further comprises merging at least one pair of the plurality of triplets and inverted triplets to form at least one mutual relation triplet in which a respective the predicate edge define a mutual relation between respective the entities.

Optionally, each the triplet comprises a set of bits for defining a respective the predicate edge.

Optionally, the plurality of entry records are sorted in a continuous decreasing function.

Optionally, the list is topologically compressed.

Optionally, at least some of the plurality of entry records are compressed by unifying members of the group according to their predicate edges.

Optionally, each the predicate edge has a bit array indicative of a weight pertaining to a relationship between respective the subject entity and respective the attribute entity.

According to some embodiments of the present invention, there is provided a method of providing adjacency data of a vertex key in a graph. The method comprises receiving a vertex key marked as one of a plurality of entities connected by a plurality of predicate edges in a contextual relation graph, providing a plurality of entry records each defining for another the entity, adjacency data with other of the plurality of entities, each of at least some of the plurality of entities in the plurality of entry records, being defined by another of a plurality of unique pointers to another physical memory of a respective the entry record, using the unique pointer to access a respective the physical memory address and retrieve a respective the entry record, extracting from the respective entry record contextual respective the relation data, and outputting the respective adjacency data.

Optionally, the vertex key is a linguistic unit and the adjacency data.

Optionally, the extracting comprises identifying which of the plurality of unique pointers is of entries which are contextual related to the vertex key and accessing respective the entry records to extract respective the adjacency data.

Optionally, the adjacency data comprising an N degree connected entities acquired by N memory accesses using N unique pointers.

According to some embodiments of the present invention, there is provided a system of providing adjacency data. The system comprises an input interface for receiving a vertex key, a repository hosting, a matching table defining an association between a plurality of vertices and a plurality of unique pointers to a plurality of physical memory addresses, and an adjacency list of a contextual relation graph mapping a plurality of predicate edges connecting among a plurality of vertexes each set for another of a plurality of entities, the adjacency list having a plurality of entry records each defining, for a certain entity of the plurality of entities, a group of the plurality of predicate edges which connects some of the plurality of entities thereto, the plurality of entry records being sorted according to a prevalence of each the entity in the list, wherein each the entity in the adjacency list is represented by a different the unique pointer. The system further comprises a manger of using the matching table and the adjacency list for retrieving adjacency data pertaining to the vertex key and

an output interface of outputting the adjacency data.

Optionally, the manger retrieves the adjacency data in a single memory access operation by using a respective the unique pointer to a respective the physical memory address of a respective the entry record.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a directed contextual relation graph;

FIG. 2 is a schematic illustration an adjacency list which comprises a plurality of entity records, according to some embodiments of the present invention;

FIG. 3 is a flowchart of a method of generating a plurality of entity records for an adjacency list of a contextual relation graph, according to some embodiments of the present invention;

FIG. 4 is a schematic illustration of a segment of a directed contextual relation graph, according to some embodiments of the present invention;

FIG. 5 depicts a file which is generated to store an adjacency list which is based on the segment depicted in FIG. 4, according to some embodiments of the present invention;

FIG. 6 is a flowchart of a method of retrieving one or more adjacent vertices in response to a provided vertex using a graph topology dataset, according to some embodiments of the present invention; and

FIG. 7 is a schematic illustration of a system of providing adjacency data, for example for implementing the method depicted in FIG. 6, according to some embodiments of the present invention.

### DESCRIPTION OF EMBODIMENTS OF THE INVENTION

The present invention, in some embodiments thereof, relates to a contextual relation records and, more particularly, but not exclusively, to a method and system of identifying contextual relations, method and system of generating a dataset for mapping contextual relation, and an adjacency data set, such as contextual relation data.

According to some embodiments of the present invention, there is provided a method of creating a dataset having an adjacency list of a graph, such as a contextual relation graph, mapping a plurality of predicate edges connecting among a plurality of vertexes, each set for another of a plurality of entities, such as linguistic units. The method is based on a list of predicate triplets and inverted predicate triplets extracted from the graph, which is optionally a contextual relation graph. Each one of the triplets (and the inverted predicate triplets) has a subject entity and an attribute entity from entities of the graph and a predicate edge from predicate edges of the graph. The triplet defines a relation between a subject entity and an attribute entity. This list allows creating a dataset having an adjacency list of the graph. The adjacency list has entry records which define, for each entity, a group of predicate edges which connects some of the other entities. The entry records are ordered according to a prevalence of each entity in the list. Now, each entity, in the adjacency list, is replaced with a unique pointer to a physical memory address of a respective of the entry records. This allows outputting the dataset for facilitating the identification of contextual relations, adjacencies, and/or other graph connection based information.

According to some embodiments of the present invention, there is provided a method of providing adjacency data of a vertex key in a graph, for example a linguistic unit in a contextual relation graph. The method is based on entry records which define, per entity, adjacency data, such as contextual relation data, with other entities. At least some of the entities in the entry records are defined by unique pointers to physical memory addresses. In use, a vertex key is received, for example from a client terminal in a network. The vertex key is marked as one of a plurality of entities connected by a plurality of predicate edges in a contextual relation graph. Then, the respective unique pointer to access a respective physical memory address is identified and used to retrieve a respective entry record. Now adjacency data is extracted from the respective entry record. This allows outputting the respective adjacency data, for example as a response to the received vertex key.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

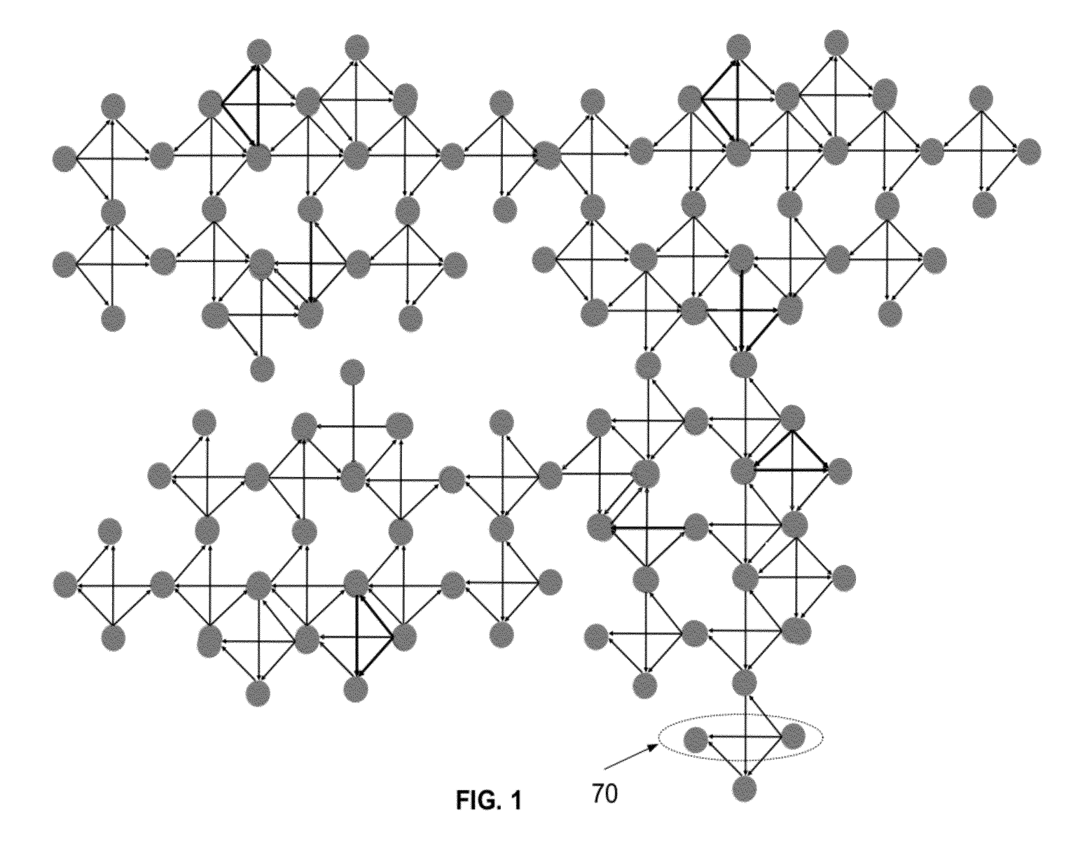

Reference is now made to FIG. 1, which is a schematic illustration of a directed contextual relation graph. The graph may be divided to predicate triplets where each predicate triplet defines a source edge (vertex), a predicate arc, and a target edge (vertex), for example as shown at 70. Each source or target edge, which may be respectively referred to as a vertex or a global vertex key, a source entity and a target entity, represents a data unit in a connected base of information, for example a junction in a road, a node in a computer network, a person in a social network, linguistic unit of characters used to identify a unique entity and/or a unique resource on the Internet, for example a Uniform Resource Identifier (URI). For brevity, a linguistic unit means one of the natural units into which linguistic messages can be analyzed, an element consisting of or related to language, such as a word, a term, a combination of words, and the like. For brevity, such a URI may be referred to herein as a unique entity. For example, a unique entity may be a name such as “Britney Spears”, an object, such as “Golf”, a property, such as “window”, and a characteristic, such as “Blonde”. An edge may also be a linguistic unit of characters used to identify a literal that represents a plurality of unique entities. For brevity, such an entity may be referred to herein as a literal. For example, a literal may be a type for example of a person, a place, an animal, a movie, a product, a characteristic, a property, and a prototype, and/or a value. The predicate arc points toward the target edge and includes a predicate verb which requires, permits, or precludes the unique entity and/or literal in the target edge to complete a predicate that modifies the entity defined in the source edge. For example, the predicate provides information about the entity defined in the source edge, such as what the entity defined in the source edge is doing or what the entity defined in the source edge is like. For example, predicate triplet that includes the source edge with the entity “banana”, the target edge with the entity “yellow” and the predicate arc with the verb “is” provides the contextual relation “banana is yellow”. Optionally, each predicate arc includes a bit array for representing a weight in the represented connection. In such a manner, the connection between the source and target entities is weighted, for example estimated traffic between two entities which are indicative of junctions, estimated proximity between two entities which are indicative of people in a social network, estimated traffic between two nodes which are indicative of nodes in a computer network, and the like.

The graph may be defined by an adjacency list of predicate triplets. According to some embodiments of the present invention, entities, which are defined as source edges, are arranged in a dataset, such as a file, referred to herein as a graph topology dataset. Each such entity is defined in an entity record.

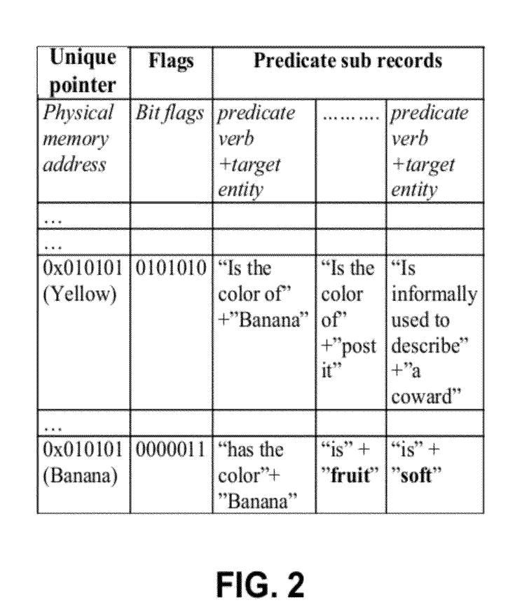

Reference is now made to FIG. 2 which is a schematic illustration an adjacency list which comprises a plurality of entity records 300, each set for storing contextual relations of an entity according to some embodiments of the present invention. Each entity record 300 includes a unique pointer 301, which is optionally the physical address of the entity record in the memory, for example with reference to the file the dataset storage address. The entity record 300 further comprises one or more predicate sub records which include a predicate verb and a target entity. The one or more predicate sub records are optionally extracted from the graph by identifying all the predicate triplets in which a certain entity is defined as a source edge.

Optionally, a linguistic unit identity dataset, which may be referred to herein as vertex string file, is generated for associating between a plurality of unique pointers and a plurality of vertices. In such a manner, a unique pointer may be stored instead of a linguistic unit, for example defining a source edge and/or a target edge. Optionally, the records in the Vertex String file are arranged according to the unique pointer values. Optionally, a hash table holds a unique hash for each linguistic unit its unique pointer from the respective entity record 300. This table enables the reverse mapping from vertices, such as linguistic units, to IDs. The hash table is optionally generated by a perfect hashing method.

Optionally, each entity record 300 further comprises one or more flag bits 302 which are used to indicate one or more contextual relations of the entity that is defined by the unique pointer, for example as described below. It should be noted that different entity records may have different sizes. The size of each entity record is affected by the number of predicate sub records it contains. This affects the unique pointers of the other entities when the unique pointer of an entity is defined according to its address in the memory.

Optionally, a predicate translation dataset, which may be referred to herein as predicate mapping table, is generated for associating between a plurality of unique predicate IDs and a plurality of representations describing the predicate verbs and/or predicate contextual relations, for example linguistic unit representations. In use, the predicate IDs are used to define the values of the predicate arcs in the predicate sub records.

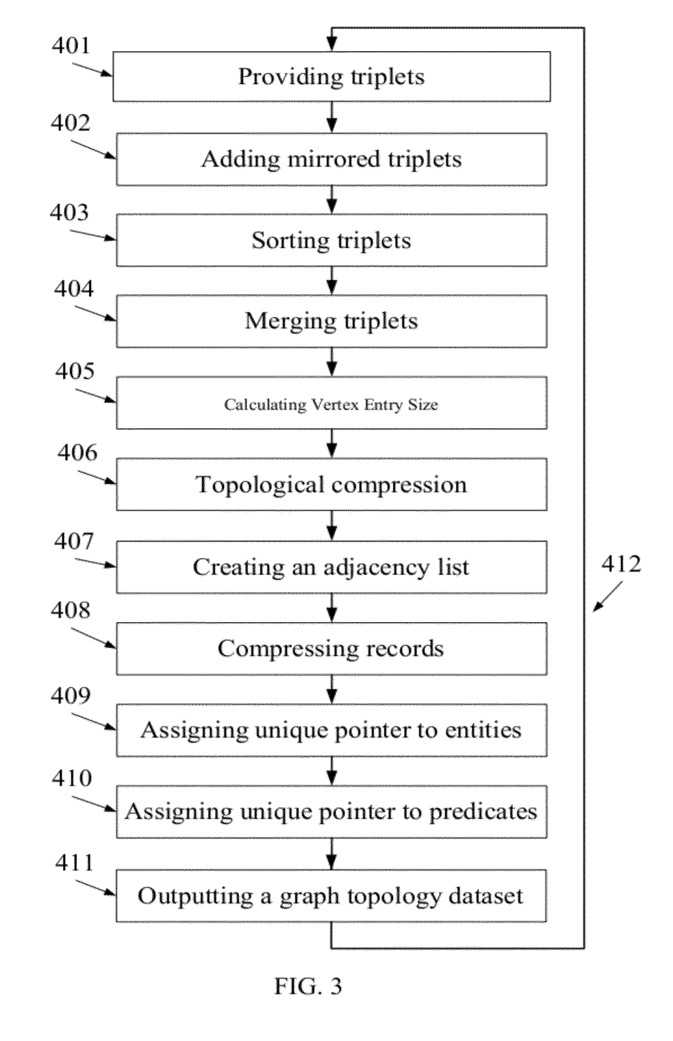

Reference is now made to FIG. 3, which is a flowchart of a method of generating a plurality of entity records for an adjacency list of a contextual relation graph, according to some embodiments of the present invention.

First, as shown at 401, a list of predicate triplets is provided, for example extracted from a contextual relation graph. Identical predicate triplets are optionally deleted, if found.

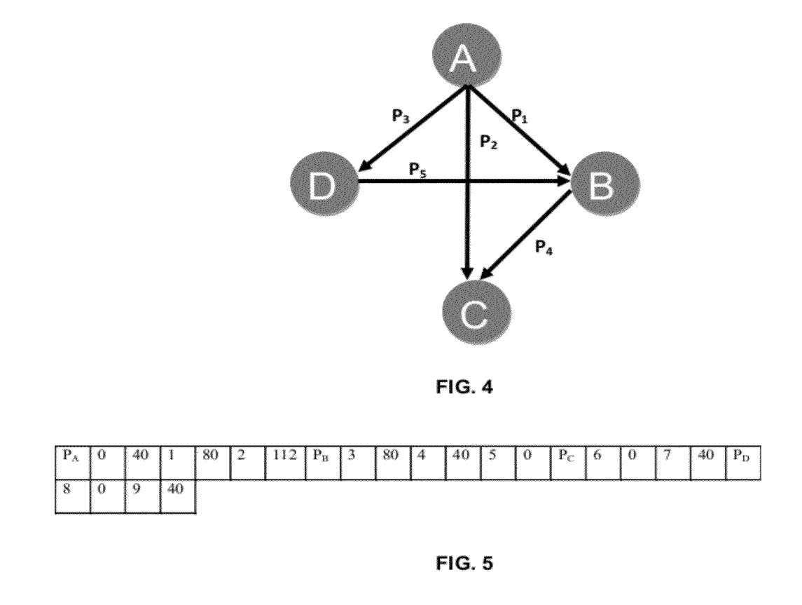

For example, for the graph segment depicted in FIG. 4, the list of predicate triplets is defined as follows: A P₁ B, A P₂ C, A P₃ D, B P₄ C, and D P₅ B.

Then, as shown at 402, for each predicate triplet in the list, a mirrored version is created and added to the list. As used herein, a mirrored predicate triplet is a predicate triplet generated by inverting the predicate verb or relation to reflect an inverted meaning and setting a target entity as a source entity and a source entity as a target entity. For example, “is” may be replaced with “is an attribute of” and “part of” may be replaced with the predicate verb “comprises”. It should be noted that this process may generate a number of predicate triplets with the same meaning. This is formed when the predicate value and/or relation is bi-directional, for example, the relations “a friend of”, “connected to”, “adjacent to”, “blended with” and the like. For example, for the graph segment depicted in FIG. 4, the list is updated to include the mirrored predicate triplets as follows: A P₁ B, B˜P₁ A, A P₂ C, C˜P₂ A, A P₃ D, D˜P₃ A, B P₄ C, C˜P₄ B, D P₅ B, and B˜P₅ B. In such embodiments, redundant predicate triplets may be deleted and only one representation per meaning may remain.

According to some embodiments of the present invention, only some of the predicate triplets are mirrored to reduce or avoid redundant predicate triplets. For example, predicate triplets with literals as target entities, such as numbers, sizes, nonspecific names, and nonspecific values, are not mirrored. As literals are used to express particular values of unique entities, a predicate triplet with a mirrored literal does not describe a meaningful contextual relation. For example, the minoring of the predicate triplet Danny weights 68 may not have a practical for most of the contextual relation systems as the meaning of 68 has infinite number of meanings. Optionally, the entities of predicate triplets are analyzed, for example matched with a list of literals, to identify whether they should be mirrored or not.

According to some embodiments of the present invention, some predicate sub records and/or source entities have inherit literal based predicate sub records and/or literal entities. For example, the predicate sub record which includes the predicate verb “is a” and the lateral “dog” includes references the inherited predicate sub records “is barking“, “is a mammal”, “is walking on 4 legs”, and the like. In such a manner, the number of predicate sub records, which describe a unique entity such as a dog is reduced substantially. One predicate sub record is sufficient to indicate all the inherited characteristics.

In such an embodiment, an inherency dictionary file has to be provided with the generated graph topology dataset. Optionally, predicate sub records and/or entities with the references to inherited predicate sub records and/or entities has an inherency flag that is indicative of the inherit records and/or entities.

According to some embodiments of the present invention, the contextual relation graph is analyzed to identify repetitive patterns. In such an embodiment, predicate sub records and/or entities with inherited predicate sub records and/or entities may be identify and recorded in the inherency dictionary file in advance.

Now, as shown at 403, the predicate triplets and the mirrored predicate triplets in the list are sorted according to the source entity, and then by entity degrees of the source entities, optionally in a decreasing order. Optionally, the sorting is performed as described in Jeffrey Dean and Sanjay Ghemawat, MapReduce: Simplified Data Processing on Large Clusters, OSDI'04: Sixth Symposium on Operating System

Design and Implementation, San Francisco, Calif., December, 2004, which is incorporated herein by reference. Other sorting methods may also be used. The list of predicate triplets is sorted according to the target sources so that predicate triplets having a common target source are in placed adjacently. Optionally, the sorting is alphabetical. For example, the aforementioned list that is includes mirrored predicate triplets and generated according to the graph segment depicted in FIG. 4 is sorted as follows: A P1 B, A P2 C, A P3 D, B P4 C, B˜P5 B, B˜P1 A, C˜P2 A, C˜P4 B, D˜P3 A, and D P5 B.

Optionally, as shown at 404, mutual relation predicate triplets are formed to reduce computational complexity. A mutual relation predicate triplet may be formed by taking a predicate triplet that defines a contextual relation between first and second entities by a predicate arc pointing from the first entity to the second entity and merging it with a predicate triplet that defines a contextual relation between the first and second entities by the same predicate arc pointing from the second entity to the first entity. In order to indicate the directivity of the predicate arc two flagging bits are used. For example, “01” is indicative of a contextual relation from the source entity to the target entity, “10” is indicative of a contextual relation from the target entity to the source entity, and “11” is indicative of a mutual relation in which both entities have the same contextual relation to one another, for example “friend of”, “co-author of”, “communicate with”, and “compatible”.

Optionally, as shown at 405, the entry size of each unique source entity in the list is calculated. For example, an entity degree is calculated and, marked for each unique source entity in the list. For example, this degree is calculated and marked by summing the number of edges which are directed from the unique source entity to different target edges. For example, for the graph segment depicted in FIG. 4, the following degrees are calculated: A: 3, B: 3, C: 2, and D: 2. Optionally, the list generated in 402 is sorted before this calculation, facilitating a straight forward degree calculation for a certain entity by summing the number of predicate triplets with the certain entity as a source target that sequentially appear in the list. It should be noted that when tripets are merged, as depicted in 404, the calculation of the entity degree is not indicative of the size. In such an embodiment, actual size has to be calculated.

Note that when the adjacency list is generated for a large scale contextual relation graph, for example of more than 100 million predicate triplets, the aforementioned decreasing order sorting creates a continuous decreasing function. By selecting only a few points on the graph, for example 40, the degree of each vertex can be estimated very accurately without disk access.

Optionally, as shown at 406, a topological compression is performed to compress the list, for example as described in G. Taubin and J. Rossignac, “Geometric compression through topological surgery”, Research Report IBM, RC-20340, January 1996, which is incorporated herein by reference.

Now, as shown at 407, an adjacency list is created and optionally stored in a dataset that is referred to herein as a graph topology dataset. The adjacency list is created according to the sorted list of predicate triplets and mirrored predicate triplets so that each row in the list represents a respective member of the sorted list. For example, an adjacency list that is created according to the aforementioned sorted list and generated for the graph segment depicted in FIG. 4 is set as follows: A P₁ B P₂ C P₃ D, B P₄ C˜P₅ B˜P₁ A, C˜P₂ A˜P₄ B, and D˜P₃ A P₅ B.

Optionally, as shown at 408, entity records in the adjacency list are compressed. Optionally, predicate sub records having a common predicate arc are compressed by forming a multi target predicate sub record which defines a predicate verb and a plurality of target entities. Such a multi target predicate sub record may include a list of any number of target entities, for example 2, 100, 1000, 100000, and/or any intermediate or larger number. It should be noted that in such an embodiment, the unique pointers have to be defined according to the actual physical addresses of the stored records and cannot be based only on the number of target entities.

Than, as shown at 409, a unique pointer is assigned for each source and target entity in the adjacency list. In such an embodiment, all the vertices, for example the linguistic units, in the adjacency list are replaced with unique pointers, which are actually the physical memory addresses of the respective entry records. The unique pointer is optionally the storage location of a respective adjacency list row in the storage, for example according to a physical memory address in the storage device, for example in a hard disk drive (HDD). It should be noted that after sorting the listed predicate triplets and assigning unique pointers, the unique pointer may be computed by adding the size of a Vertex String file pointer the unique pointer of the previous vertex, and adding the degree of the previous vertex multiplied by the edge record size. For example, the unique pointer (abbreviated in the functions hereinbelow as ID) is set as follows:

ID(Vertexₙ)=ID(Vertexₙ₋₁)+VertexEntrySizeₙ₋₁

For example, in the aforementioned adjacency list that is created according to the aforementioned sorted list for the graph segment depicted in FIG. 4, unique pointers are defined as follows:

ID(A)=0;

ID(B)=0+16+3×8=40;

ID(C)=40+16+3×8=80; and

ID(D)=80+16+2×8=112

where the size of each unique pointer is 8 bytes and the size of each linguistic unit pointer is 16. It should be noted that if the records of the adjacency list are compressed, a calculation which is based on the number of target entities (vertexes) does not work as some target entities may require less storage space than others.

Now, as shown at 410, predicate relations are assigned with predicate unique pointers. The unique pointers for predicates are optionally assigned sequentially. For example, in the aforementioned adjacency list that is created according to the aforementioned sorted list for the graph segment depicted in FIG. 4, predicates are assigned with the following predicate unique pointers (abbreviated herein as ID): ID (P1)=0, ID (P2)=1, ID (P3)=2, ID (P4)=3, ID (˜P5)=4, ID (˜P1)=5, ID (˜P2)=6, ID (˜P4)=7, ID (˜P3)=8, and ID (P5)=9.

Now, as shown at 411, a graph topology dataset is outputted, facilitating the identification of contextual relations between different entities. For example, FIG. 5 depicts a file that is generated according to the aforementioned adjacency list, where P_{A}, P_{B}, P_{C} and P_{D} denotes unique pointers to the vertices representing entities (vertices) A, B, C and D, which are depicted in FIG. 4, respectively in the Vertex String file.

As described above, a Vertex String file may be generated for storing global vertex keys that will be associated with the internal vertex representations. For example, when the vertex key is a linguistic unit, the association is between the plurality of unique pointers which are used to mark the source and target entities (graph vertices) and a plurality of linguistic units. These global vertex IDs are stored as a sequence in a single file. In the graph topology dataset, there is a pointer at the beginning of each adjacency list row. This pointer points to the location of the linguistic unit which describes the source entity of that row in the vertex string file. Optionally, the unique pointers are retrieved through a hash table. The hash code of the hash table is chosen to have sufficient length such that there are no two global vertex keys, for example linguistic units such as strings, which generate the same hash code (collisions). Such a hash function is known as a perfect hash. The process for creating such a hash table may be implemented as follows:

finding the linguistic unit for a unique pointer using the pointer to the Vertex String file in the respective entity record;

computing the hash of the linguistic unit;

storing the hash code and the unique pointer in a list, for example as follows: HC1 ID1,

HC2 ID2 and so on and so for the; and

sorting the list according to the hash codes. After the hash table is ready, retrieving a unique pointer for a given linguistic unit is done by computing the hash code for the linguistic unit, finding the hash code in the hash table by search, for example, using binary search, and retrieving the unique pointer from the entry of the hash code in the table.

Optionally, the hash code is set according to an offset of the unique pointer. For example, the last bits of a unique pointer are used for calculating a linguistic unit offset of 4 bytes.

The graph topology dataset allows accessing adjacency data, such as contextual relation data, of an entity by a single search operation that requires a single memory access to the location of the respective entity record in the file, which is simply the unique pointer of the entity. As used herein, a memory access may be an HDD operation, such as moving the head of a disk drive radially, for example, to move from one track to another and/or to move the pointer that marks the next byte to be read from or written to a file.

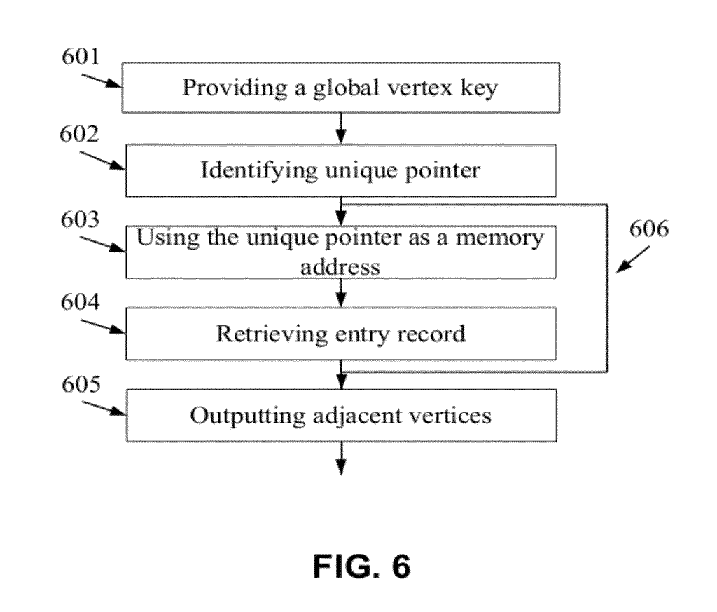

Reference is now made to FIG. 6, which is a flowchart of a method of retrieving one or more adjacent vertices, such as contextually related linguistic units, such as words, in response to a provided vertex (such as a linguistic unit) based on the aforementioned graph topology dataset, according to some embodiments of the present invention. First, as shown at 601, a global vertex key, such as a certain linguistic unit is provided. The global vertex key may be provided from a search engine, a contextual disambiguation tool, a contextual in text advertising and/or linking tool, and the like.

Then, as shown at 602, a unique pointer, associated with the provided global vertex key, is identified by searching for a respective record in a global vertex key-internal vertex address mapping, such as the aforementioned Vertex String file. This unique pointer is the address in a memory device which stores an adjacency list, such as the graph topology dataset. Now, as shown at 603 and 604, the unique pointer is used to access and retrieve a respective entry record that includes unique pointers of other vertices which are adjacent to the provided vertex. As the unique pointer is the actual memory address, the access is done directly, with relatively low computational complexity. Now, as shown at 605, one or more adjacent vertices, for example contextually related words or contextual relations (predicate sub records) are outputted. Optionally, the vertex-string dataset is used to identify the words by matching unique pointers documented in the retrieved entry record to potential vertices. As shown at 606, this process (603-604) may be repeated with each one of the adjacent edges, facilitating the identification of second order contextual associations. This process may be iteratively repeated, facilitating the identification of third order contextual associations, fourth order contextual associations, fifth order contextual associations and so on and so forth. For example, when the word is “banana”, the Vertex String file is searched to identify a unique pointer of an entry record that documents the contextual relations of banana with other words, for example the predicate sub records. Then, an address in the memory which stores the graph topology dataset is accessed to retrieve the entry record of “banana”, where the accessed address is the unique pointer. The entry record includes the unique pointers of all the contextually related words, for example “yellow” from the contextual relation “is yellow”, “brown” from the contextual relation “is getting brown with time”, and “Musa” from the contextual relation “of the genus Musa”. This allows accessing each one of the entry records of these contextual related words with a single memory access. For example, the entry records of the entries (words) “yellow”, “brown”, and “Musa” may be accessed to provide second order contextual relations.

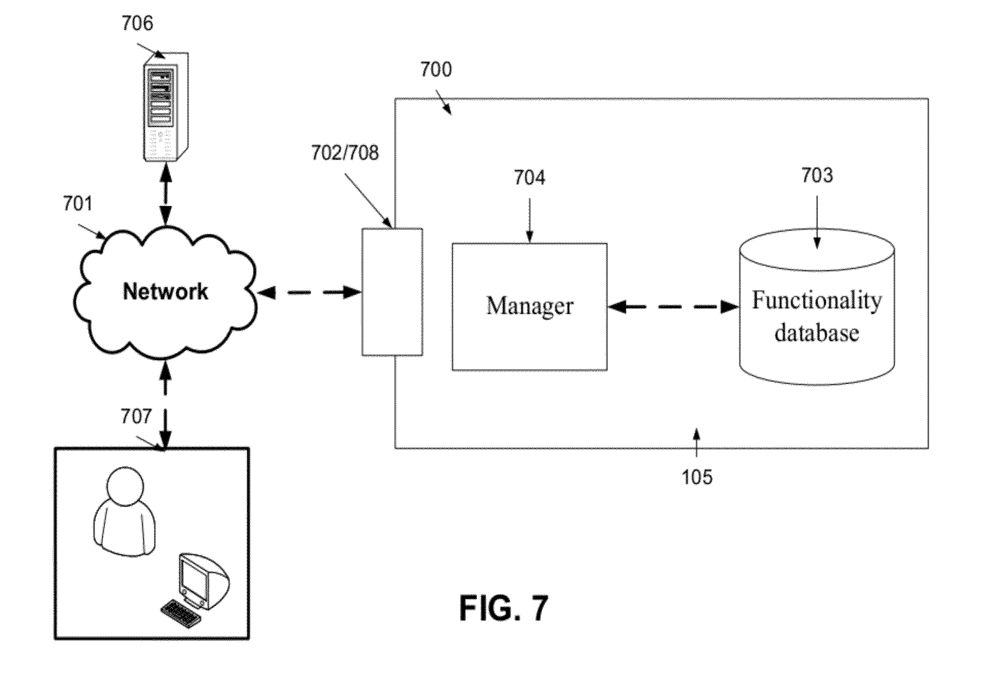

Reference is now made to FIG. 7, which is a schematic illustration of a system 700 of providing adjacency data, such as contextual relations data, for example for implementing the method depicted in FIG. 6, according to some embodiments of the present invention. The system 700 is optionally implemented by on one or more servers which are connected to a computer network 701, such as the Internet. The system 700 includes an input interface 702 for receiving a linguistic unit or a value which represents an entity which is mapped in a directed contextual relation graph. The linguistic unit and/or value, for brevity referred to herein as a linguistic unit, may be received from a local module and/or from an external node which is connected to the network 701, such as a remote server 706 and/or client terminal 707. For example, the input interface 702 may include a network interface card (NIC), a router, and/or a receiving module and a repository 703, such as one or more HDDs which host a matching table, such as the aforementioned vertex string file and an adjacency list, such as the aforementioned graph topology dataset. The system 700 further includes a manger 704 which uses the matching table and the graph topology dataset for identifying adjacency data, such as contextual relation data, pertaining to the received linguistic unit or value and an output interface 708 of outputting the adjacency data, such as contextual relation data. The system 700 may be part of a search engine, a contextual disambiguation tool, a contextual in text advertising and/or linking tool, and the like.

It should be noted that when a data structure, such as a tree is used for describing contextual relations, the number of memory accesses which are required to reach a certain entry out of N entries is log₂(N). For example, when a graph with 100 million entries is used in a tree-based data structure, up to 28 memory accesses are required to reach a node. The number of memory accesses which are required to reach a certain entry in a graph topology dataset of 100 million entries is one. As the graph topology dataset mapping is based on mirrored predicate triplets, which are included in the graph itself, finding the source entry of a target entry is done in a single memory access. Performing such an operation in a regular data structure requires searching a respective database to find and process the rows in which the requested source entry is present.

Optionally, the graph topology dataset may be used to facilitate a single memory access operation to acquire the number of entities which are contextually related to a source address by a predicate arc pointing thereto and referred to herein as an outdegree entity.

Optionally, the graph topology dataset may be used to facilitate a single memory access operation to acquire the number of entities which are contextually related to a source address by a predicate arc pointing therefrom and referred to herein as an indegree entity.

Optionally, the graph topology dataset may be used to facilitate a single memory access operation to acquire the entities which are contextually related to a source address by a predicate arc pointing thereto and referred to herein as outedges.

Optionally, the graph topology dataset may be used to facilitate a single memory access operation to acquire the entities which are contextually related to a source address by a predicate arc pointing therefrom and referred to herein as inedges.

Optionally, the graph topology dataset may be used to acquire an N-degree connected entity in N memory accesses. For example, the graph topology dataset may be used to acquire second degree connected entities, namely entities which are adjacent of adjacent of entities. In such an embodiment, a certain contextually related entity is identified in a single memory access using the graph topology dataset and then the certain contextually related entity is used as a source entity to acquire second degree connected entities and so one and so forth.

According to some embodiments of the present invention, the size of the graph topology dataset may be computed as follows:
Size=|V|*Pointer+count(distinct<source vertex,predicate>where the group size>3)*predicate_header_size+count(<source vertex,predicate> where the group size>3)*|Edge-record|/2+count(<source_vertex,predicate> where the group size<3)*|Edge-record|

where |V| denotes the number of vertices,
   |Pointer| denotes the size of the pointer to the Vertex String file, |Edge-record| denotes the record size for each edge in the adjacency list rows, and predicate_header_size=|Edge-record|/2. For example, for a large scale contextual relation graph of a database such as Wikipedia, which has 100 million entities and 1 billion edges (predicate arcs), assuming the pointer size of the unique pointer entity is 8 bytes and the edge record size (predicate arc SIZE) is 8 bytes, a total size is about 4 GB (3 GB strings data).

It is expected that during the life of a patent maturing from this application many relevant systems and methods will be developed and the scope of the term storage, memory, and display is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of creating a dataset having an adjacency list of a graph mapping a plurality of predicate edges connecting among a plurality of vertexes each set for another of a plurality of entities, comprising:
providing a list having a plurality of predicate triplets and a plurality of inverted predicate triplets extracted from the graph, each said triplet and said inverted predicate triplet having a subject entity and an attribute entity from said plurality of entities and a predicate edge, from said plurality of predicate edges, defining a relation between said subject entity and said attribute entity;
creating a dataset having an adjacency list of said graph, said adjacency list having a plurality of entry records each defining, for a certain entity of said plurality of entities, a group of said plurality of predicate edges which connects some of said plurality of entities thereto, said plurality of entry records being ordered according to a prevalence of each said entity in said list;
replacing each said entity in said adjacency list with a unique pointer to a physical memory address of a respective of said plurality of entry records; and
outputting said dataset.

2. The method of claim 1, wherein said graph is a contextual relation graph.

3. The method of claim 1, further comprising generating a matching table for associating between a plurality of vertex keys and a plurality of unique pointers so as to allow converting a received linguistic unit to a certain unique pointer and using said certain unique pointer for selecting one of said plurality of entry records.

4. The method of claim 1, wherein said providing further comprises merging at least one pair of said plurality of triplets and inverted triplets to form at least one mutual relation triplet in which a respective said predicate edge define a mutual relation between respective said entities.

5. The method of claim 1, wherein each said triplet comprises a set of bits for defining a respective said predicate edge.

6. The method of claim 1, wherein said plurality of entry records are sorted in a continuous decreasing function.

7. The method of claim 1, wherein said list is topologically compressed.

8. The method of claim 1, wherein at least some of said plurality of entry records are compressed by unifying members of said group according to their predicate edges.

9. The method of claim 1, wherein each said predicate edge has a bit array indicative of a weight pertaining to a relationship between respective said subject entity and respective said attribute entity.

10. A method of providing adjacency data of a vertex key in a graph, comprising:
receiving a vertex key marked as one of a plurality of entities connected by a plurality of predicate edges in a contextual relation graph;
providing a plurality of entry records each defining for another said entity,
adjacency data with other of said plurality of entities, each of at least some of said plurality of entities in said plurality of entry records, being defined by another of a plurality of unique pointers to another physical memory of a respective said entry record;
using said unique pointer to access a respective said physical memory address and retrieve a respective said entry record;
extracting from said respective entry record contextual respective said relation data; and
outputting said respective adjacency data.

11. The method of claim 10, wherein said vertex key is a linguistic unit and said adjacency data.

12. The method of claim 10, wherein said extracting comprises identifying which of said plurality of unique pointers is of entries which are contextual related to said vertex key and accessing respective said entry records to extract respective said adjacency data.

13. The method of claim 10, wherein said adjacency data comprising an N degree connected entities acquired by N memory accesses using N unique pointers.

14. A system of providing adjacency data, comprising:
an input interface for receiving a vertex key;
a repository hosting:
a matching table defining an association between a plurality of vertices and a plurality of unique pointers to a plurality of physical memory addresses, and an adjacency list of a contextual relation graph mapping a plurality of predicate edges connecting among a plurality of vertexes each set for another of a plurality of entities, said adjacency list having a plurality of entry records each defining, for a certain entity of said plurality of entities, a group of said plurality of predicate edges which connects some of said plurality of entities thereto, said plurality of entry records being sorted according to a prevalence of each said entity in said list, wherein each said entity in said adjacency list is represented by a different said unique pointer;
a manger of using said matching table and said adjacency list for retrieving adjacency data pertaining to said vertex key; and
an output interface of outputting said adjacency data.

15. The system of claim 14, wherein said manger retrieves said adjacency data in a single memory access operation by using a respective said unique pointer to a respective said physical memory address of a respective said entry record.
